(19) United States
(12) Patent Application Publication
(10) Pub. No.: US 2023/0271665 A1
(43) Pub. Date: Aug. 31, 2023

(54) Variable-geometry bicycle frame and method for dynamic changes to the geometry of a bicycle frame

(71) Applicant: UPTURN STUDIO SPØLKA Z ORGANICZONA ODPOWIEDZIALNOSCIA, Bialystok (PL)

(72) Inventor: Aleksander MARGOLIS, Warszawa (PL)

(21) Appl. No.: 18/003,150

(22) PCT Filed: Jun. 22, 2021
(86) PCT No.: PCT/PL2021/000042

§ 371 Date: Dec. 22, 2022

(30) Foreign Application Priority Data
Jun. 23, 2020 (PL) P.434421

(51) Int. Cl. B62K 3/02; B62K 25/28; B62K 19/24

(52) U.S. Cl. CPC B62K 3/02; B62K 19/24; B62K 25/286

(57) ABSTRACT

The invention relates to a variable-geometry bicycle frame. The bicycle frame consisting of a bearing element (1) comprises a front fork mount (2) and a crankset mount (3), a seat constructional part (10) comprises a saddle’s (4) clamp, an adjustment part (7), a rear wheel suspension set (20) comprises a swingarm (21) and a shock absorber (22) characterized in that, the bearing element (1) is connected by at least one articulated joint to the seat constructional part (10) and by at least one articulated joint to the rear wheel suspension set (20), and the seat constructional part (10) is connected by at least one articulated joint to the rear wheel suspension set (20) and the adjustment part (7) is movable within the range from the X position to Y position.

The subject of the present invention is a variable-geometry bicycle frame and a method for dynamic changes to the geometry of a bicycle frame, especially in regards to frames dedicated to off-road riding, characterized by a rear-wheel suspension which enables the geometry and the suspension parameters to be dynamically adjusted mid-ride. The present invention finds comprehensive application in single-track vehicles designed for travel across dynamically shifting slopes and variable terrain.

Bicycles designed for extreme mountain bike discipline are fitted with specialised suspension systems and geometrical layouts tailored to particular requirements of its sub-disciplines, ranging from the Downhill or Enduro, to Trail and Cross-Country. A number of parameters define the designated purpose of a bicycle, such as: the saddle height as relative to the mounting of crankset, the frame head angle inclination, the crankset height as relative to the ground, the top tube height, the seat post angle, the saddle inclination relative to the level, the frame suspension stroke, the leverage ratio on the shock absorber, the value of the suspension’s initial deflection (SAG); the drive influence on the suspension (anti-squat parameter) and the rear-brake influence on the suspension (anti-rise). Among the above mentioned, the parameter of the saddle height relative to the crankset mounting as well as the rear-wheel suspension stroke are recognised as some of the more essential ones. When riding uphill or across a moderately bumpy terrain it is advisable to fix the saddle high which is turn guarantees a stable pedalling posture. With the saddle mounted low, the cyclist’s body gains extra leeway for equally: weight blancing, active shock absorption over rough terrain and leaning back during steep downhill travel. The rear-wheel suspension stroke, which may be considered as the determinant of riding style for which the bicycle is designed, usually it is within the value range of 200-100 mm. A universal solution characterised by capacity for rapid adjustments of a wide spectrum of parameters, on the fly and in a quick and efficient manner, is presently highly-sought after.

A number of solutions pertaining to the bicycle constructions elements, including those dedicated to the changing of the geometry and shock-absorbing parameters, is currently known.

Currently there are a number of solutions for bicycle construction elements, including the bicycle frames dedicated to the geometry parameter changing and/or shock absorbing characteristics also during riding is known.

Adjustable telescopic seatposts are presently in wide use. The solution is commonly outlined across the web, as seen on a manufacturers website ridefox.com, for instance. It allows for dynamic mid-ride adjustment of a saddle height via a shifter located on the bicycle handlebar.

In order to lower the saddle the cyclist engages the shifter, then uses his body weight to lower its height. Upon disengaging the shifter, the saddle’s position is once again locked at the new, lowered height. To raise the saddle’s height the cyclist shifts his weight onto pedals and off the saddle and engages the shifter: the spring of the mechanism is then pushing the saddle back up. As the shifter is disengaged, the saddle position is once again fixed. The movement range of such solution is limited by the construction of the seat tube, which in certain cases entirely prevents its implementation. The method allows for a maximum adjustable saddle height range of 210 mm (however limited further to 125 cm in the case of frames dedicated for cyclists of up to 180 cm height).

A commonly used solution has been disclosed in the patent specification no. WO2013029928A1, known as a four-bar suspension with a Horst-link. It attempts to isolate both the pedalling and braking forces away from the suspension. The solution outlines the usage of the four-arm joint, whereas four elements referred to as “bars” or “links” are connected to each other by either rotating joints or a combination of rotating and sliding ones. Through the Horst-link – the suspension cam and the hydraulic-pneumatic system with the lock released by the shifter located on the handlebar, the value change of the suspension leverage ratio and, therefore, the suspension initial deflection (SAG) as well as the suspension movement range - is accomplished. In consequence the angle of a saddle changes, whereas the ratio of the arms of the front frame triangle does not.

A well-known solution pertaining to mountain bikes, described in a Pat. No. US7712757, assumes that a mountain bike comprises: rigid element which constitutes the main frame; and rear frame connected thereto by a hinge system fitted with a shock absorber. The shock absorber is connected via a pivot pin to the swingarm of the rear frame. The second, lower shock absorber anchor point is pivotally attached to the main frame lower tube with an intermediate element. The intermediate element operates as a bearing housing for the main joint on which the rear frame rotates.

Furthermore, the construction described in the above-cited patent is provided with a flexible element located between the intermediate element and the saddle tube, which, by means of compression/stretching, allows movement of the connecting element and with it the lower anchor point of the shock absorber.

A solution configured in this way allows the anchor point to move autonomously forward and backward under the influence of the chain tension exerted during pedaling (forward when force is exerted on the pedals and backward during the compression and/or braking phase without pedal action). However, the suspension ratio to the shock absorber, which is dependent on chain tension, adversely often shifts when the rear frame, when it is subjected to frequent and extreme loads in rough terrain. It destabilizes the bicycle. In addition, the overall frame stiffness is reduced due to the presence of an additional damping element during movement.

From U.S. Pat. Description No. WO2013028138, a bicycle frame solution is known that allows the bottom bracket to be moved relative to the front triangle and other bicycle components, such as the saddle and handlebars, by means of a slide mechanism. This solution allows the geometry to be improved while riding, but the adjustment mechanisms used adversely impact the final frame weight, which is no less important a parameter. Moreover, at least several slider mechanisms are needed to change several geometric parameters of the frame desired for descents/ascents.

From U.S. Pat. Description No. US9988122B2 is known a bicycle frame having a variable geometry, wherein the front triangle as well as the rear suspension is geometrically variable through the use of an eccentric mechanism. These changes allow the saddle to be tilted within 5 deg and the suspension to shock ratio characteristics to be changed, but it remains unattainable to change the height of the saddle relative to the crankset within the range desired for descents and climbs. These changes include the ability to tilt the saddle within 5 deg and change the suspension to shock ratio characteristics, but it remains unattainable to change the height of the saddle relative to the connecting rod to the extent desired for descents and climbs.

The current state of the art is still far from solving the problem of variable mountain bike geometry. Existing solutions are limited to changing either one particular parameter or several, but to a limited extent, as in the case of the solution of Pat. No. US9988122B2. Often, such an additional feature is very detrimental to the weight and/or stiffness of the bike frame, or expensive to implement.

In addition, existing solutions for implementing geometry changes require complex components that the rider must control, which determines low functionality. In addition, existing solutions for implementing geometry changes require complicated systems that the rider must control, which determines low functionality.

The purpose of the present invention is to eliminate the above-mentioned drawbacks of the state of the art and to complete the invention with a solution that allows for a fast, intuitive and complete change of the geometry of a bicycle adapted to the slope of the route during riding.

The objective of the present invention is eliminating above mentioned drawbacks of the state-of-the art and complementing it with the solution which allows the complete and intuitive bicycle geometry adapted to the track sloping during its using to be changed.

These objectives are achieved by the features of the invention set forth in the independent claim. The dependent claims set forth preferred and/or particularly advantageous aspects of the invention.

According to the invention, a bicycle frame consisting of a bearing element comprising a front fork mount and a crankset mount, a seat constructional part comprising a saddle’s clamp, an adjusting assembly, a rear wheel suspension set comprising a swingarm and shock absorber. The bicycle frame according to the invention is characterized in that the bearing element is connected by at least one articulated joint to the seat constructional part and by at least one articulated joint to the rear wheel suspension set. Furthermore, the seat articulated joint part is connected by at least one articulated joint to the rear wheel suspension set. The adjusting assembly is movable within the range from the X position to the Y position. In this manner, all frame elements constitute the mechanism members in which the mainstay is the bearing element, and the driving member is the adjusting assembly, and each element performs strictly defined movement. In addition, this mechanism has a shock absorber as one of the elements of the kinematic chain that mediates between the connection of the swingarm, which attaches the rear wheel and the brake caliper, and the seat constructional part. Thus, it defines the frame that is the subject of the invention as a shock absorbing lever mechanism. Within this mechanism, there are, in addition to the bearing element and the adjusting assembly defined above in terms of function, a seat constructional part which, by its construction, determines the trajectory of movement of the saddle from the X position to the Y position, and a suspension system which, by its connection with the seat constructional part, makes it possible to change the position of the elements of the rear wheel suspension system and thus to change the rear suspension ratio (the ratio of the rear wheel displacement to the displacement of the shock absorber piston) in order to achieve a change in the suspension travel (stroke) range and effective firmness. A crankset mount, saddle’s clamp and front fork mount are all designed to the standards used in this category of bicycle.

In the advantageous aspect of the invention implementation, the seat constructional part extends from the saddle’s clamp downwards and then, towards the front fork mount, where the seat constructional part is articulated to the bearing element, movably in the plane perpendicular to the rear wheel axis. This seat constructional part solution allows the system to remain rigid and lightweight while maintaining a simple design and low manufacturing costs.

Preferably, the seat constructional part comprises a saddle support extending from the saddle’s clamp downwards and then towards the front fork mount where it is connected to the bearing element via an upper constructional link and via a lower constructional link. Furthermore, the upper constructional link is closer to front fork mount than lower constructional link, and the axes of the links, formed by drawing lines through the link connection points, cross at a point Z near a handlebar. The mentioned joints are movable in the planes perpendicular to the axis of the rear wheel.

Preferably, the seat constructional part comprises the upper constructional link articulated with the bearing element in the front fork mount area and articulated with the saddle support in central part. The saddle support is vertically oriented, with an upper end connected to the saddle and with a lower end connected to the lower constructional link. The lower constructional link is connected to the bearing element between the crankset mount and the front fork mount. Furthermore, all joints are movable in the plane perpendicular to the rear wheel axis. Such kinematics of the seat constructional part allows the saddle to move along a trajectory close to straight, which is beneficial from the point of view of ergonomics and riding characteristics. At the same time, stiffness, lightness of the system and a wide range of parameters adjustment are maintained.

Preferably, the rear wheel suspension set is connected by the swingarm to the bearing element in the area above the crankset mount. While the swingarm connects to the shock absorber which connects to the seat constructional part. Furthermore, the mentioned connections are articulated joints movable in the plane perpendicular to the rear wheel axis. Such a suspension set in the most elementary way allows changing the suspension stiffness depending on the assumed position of the seat constructional part, and its main advantage is lightness and low cost of production.

Preferably, the rear wheel suspension set comprises a lower suspension link extending from the connection with the bearing element in the crankset mount area to a connection to the swingarm in the area between the rear wheel mount and the crankset mount. While the swingarm is connected to the shock absorber and a upper suspension link which are connected to the seat constructional part. Furthermore, the mentioned connections are articulated movable in the plane perpendicular to the rear wheel axis.

In an advantageous aspect of implementing the invention, the rear wheel suspension set comprises the lower suspension link extending from the connection with the bearing element in the connecting area of the crankset mount to a connection to the swingarm in the area between the rear wheel mount and the crankset mount. The swingarm is connected to the upper suspension link, which is connected by its opposite end to the seat constructional part or the bearing element, and the shock absorber, is connected to the upper suspension link and the seat constructional part. In addition, said connections are articulated connections movable in a plane perpendicular to the axis of the rear wheel.

In the advantageous aspect of implementing the invention, the rear wheel suspension set comprises the swingarm connected to the bearing element in the connecting area of the crankset mount and the lower suspension link connected to the swingarm. The upper suspension link connected to the lower suspension link and the seat constructional part or the bearing element to which the shock absorber is connected. While the said shock absorber is connected to the seat constructional part. In addition, the said connections are articulated joints in the plane perpendicular to the axis of the rear wheel. In addition, this design allows for optimization of the characteristics related to the influence of the drive and brake on the suspension (anti-squat and anti-rise).

In the advantageous aspect of implementing the invention, the seat constructional part comprises the upper constructional link, pivotally connected to the bearing element in the front fork mount mounting area and pivotally connected to the saddle support in central portion. The saddle support is vertically oriented with its upper end connected to the saddle. The seat constructional part also includes the triple-arm lever rotatably connected to the bearing element and with its arms articulated to the lower end of the saddle support, the adjusting part and rear wheel suspension set. In addition, all connections are movable in the plane perpendicular to the rear wheel axis. Such a construction of the seat constructional part makes it possible to move the saddle along a straight trajectory within a very large range, thus increasing the range of adjustment of other parameters while maintaining the required stiffness.

Preferably, the rear wheel suspension set comprises the lower suspension link connected to the bearing element in the area of the crankset mount and connected to the swingarm in the area between the rear wheel mounting and the crankset mount. The swingarm connected to the upper suspension link and the shock absorber where the upper suspension link is connected to the triple-arm lever and the shock absorber is connected to the bearing element. In addition, the said connections are articulated joints movable in the plane perpendicular to the axis of the rear wheel. This design allows for a greater range of suspension stiffness parameter adjustment, while improving anti-squat (pedaling effect on suspension performance) and anti-rise (braking effect on suspension performance) performance.

In the preferable aspect, the adjusting assembly is the fixed between the bearing element and the seat constructional part by articulated joints movable in a plane perpendicular to the rear wheel axis.

Preferably, the adjusting assembly is connected in the area of the front fork mount, near the connection of the seat constructional part and the bearing element, to an element of the seat constructional parts. The adjusting assembly opposite end being connected to another element of the seat constructional parts. In addition, the said articulated joints are moveable in the plane perpendicular to the rear wheel axis.

In the preferable aspect, the adjusting assembly comprises a spring or a pneumatic or hydraulic cylinder operating within the range from the Y position to the X position, with a position lock.

Preferably, the position lock of the adjusting assembly is released by means of a handlebar shifter located on the handlebar. With this solution, the adjustment assembly is able to move the saddle from Y to X position, where Y position is the optimal configuration for downhill trails and X position is the more favorable configuration for pedaling, therefore more suitable for flat trails and uphill. The position lock allows to adopt any intermediate positions to suit individual preferences and route.

Method for dynamic changes to the geometry of a bicycle frame in the parameters of the saddle angle, the saddle height relative to the crankset mount, the rear suspension stroke, utilizing the adjusting assembly for variable length, wherein the bicycle frame is a shock absorbing lever mechanism, which is raised towards X position by releasing the lock of the adjusting assembly and fixed in a position between X and Y of the saddle by pressing on the saddle and locking the adjusting assembly again. In this method, it is possible to adjust the geometry of the bicycle quickly and intuitively to the changing slope of the route during operation, according to the preference of the cyclist.

The object of the invention has been illustrated by examples which do not limit its scope, but only indicate advantageous variants thereof. The device according to the invention is illustrated in the figures:

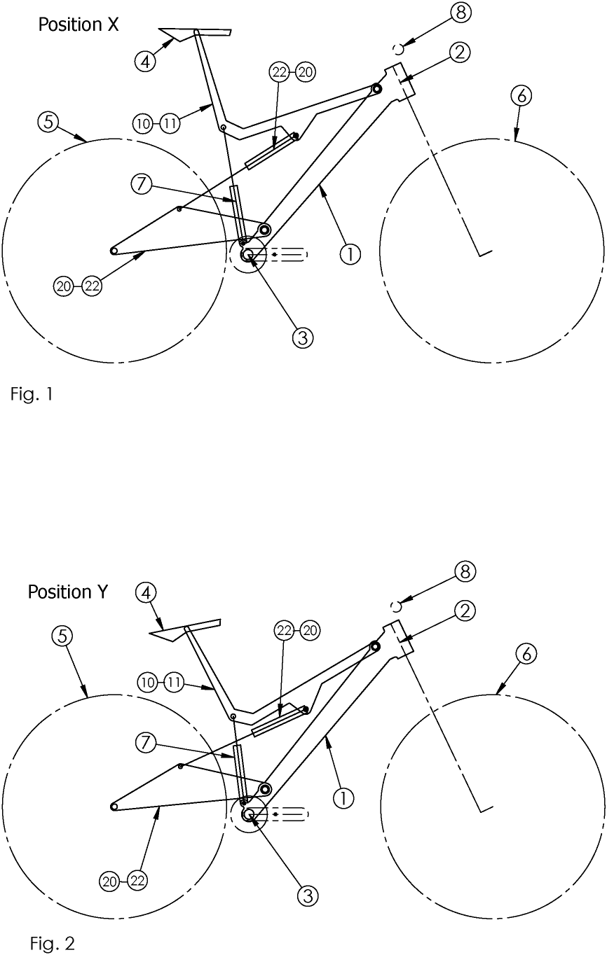

FIG. 1 - shows the side view of the bicycle equipped with the frame described by claims 1, 2, 5, 11, 13 in X position

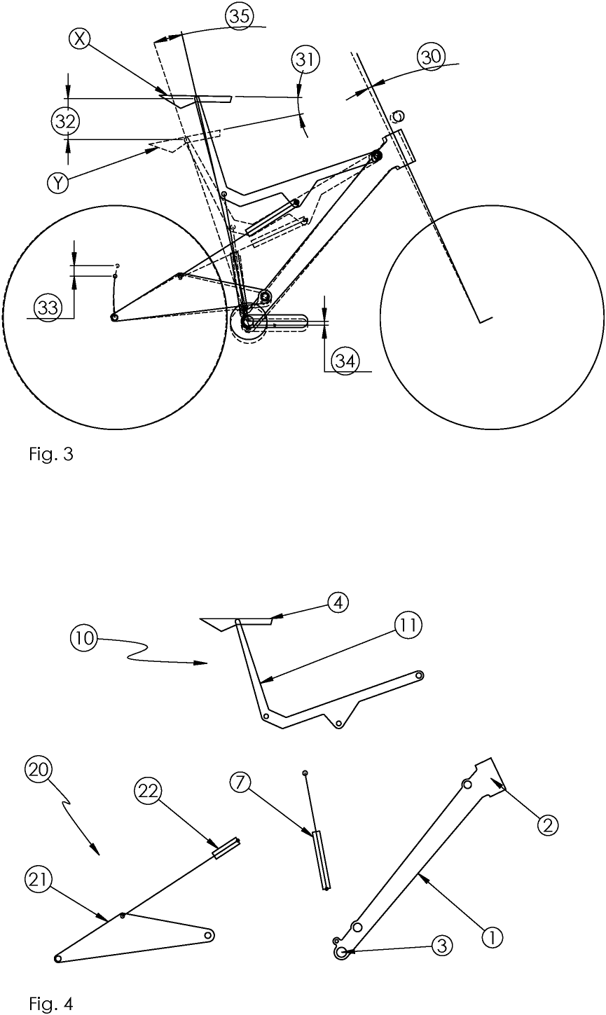

FIG. 2 - shows the side view of the bicycle equipped with the frame described by claims 1, 2, 5, 11, 13 in Y position

FIG. 3 - shows a schematic superimposition of the frame positions of FIG. 1 and FIG. 2

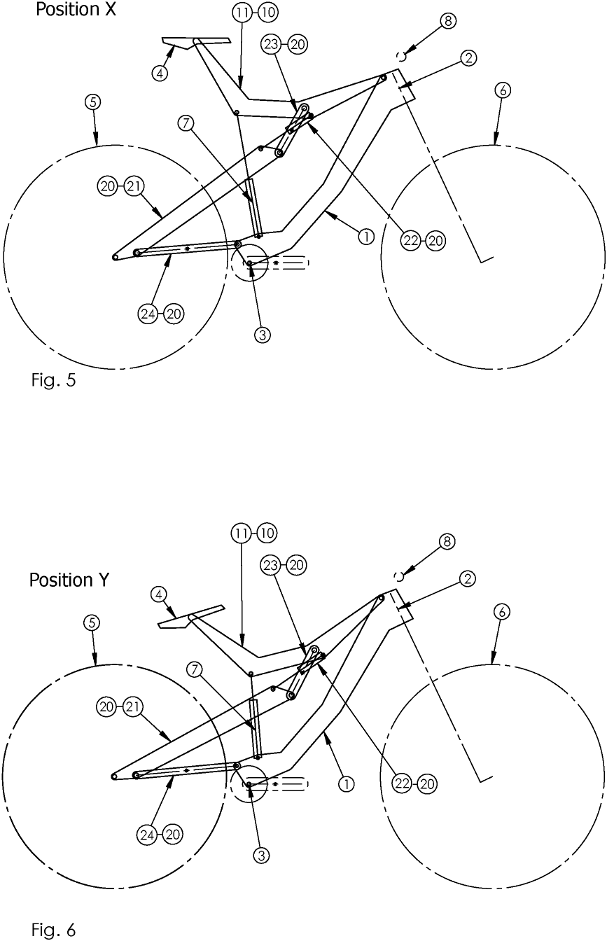

FIG. 4 - shows a side view of the frame parts shown in FIG. 3

FIG. 5 - shows the side view of the bicycle equipped with the frame described by claims 1, 2, 6, 11, 13 in X position

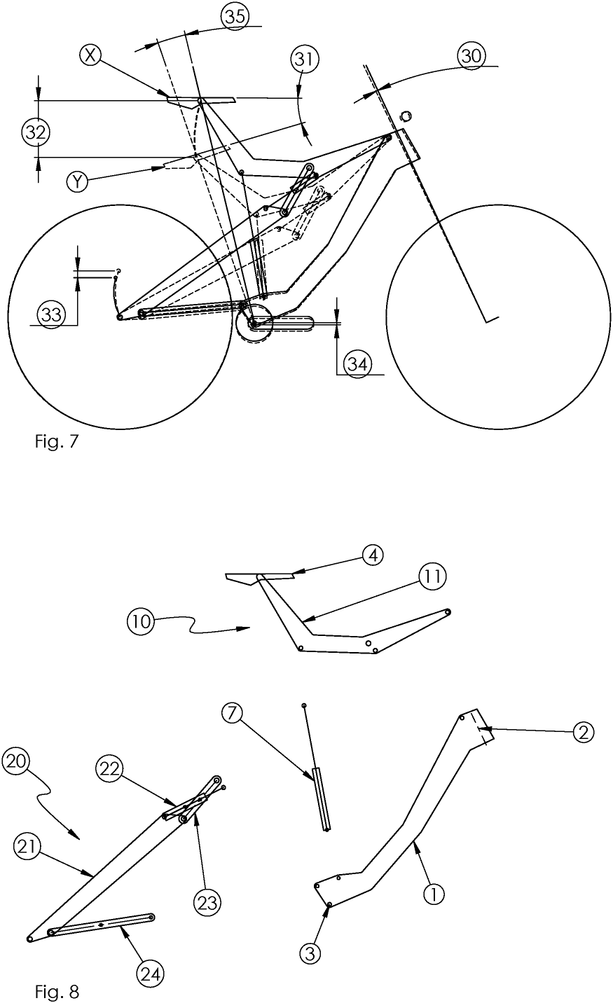

FIG. 6 - shows the side view of the bicycle equipped with the frame described by claims 1, 2, 6, 11, 13 in Y position

FIG. 7 - shows a schematic superimposition of the frame positions of FIG. 5 and FIG. 6

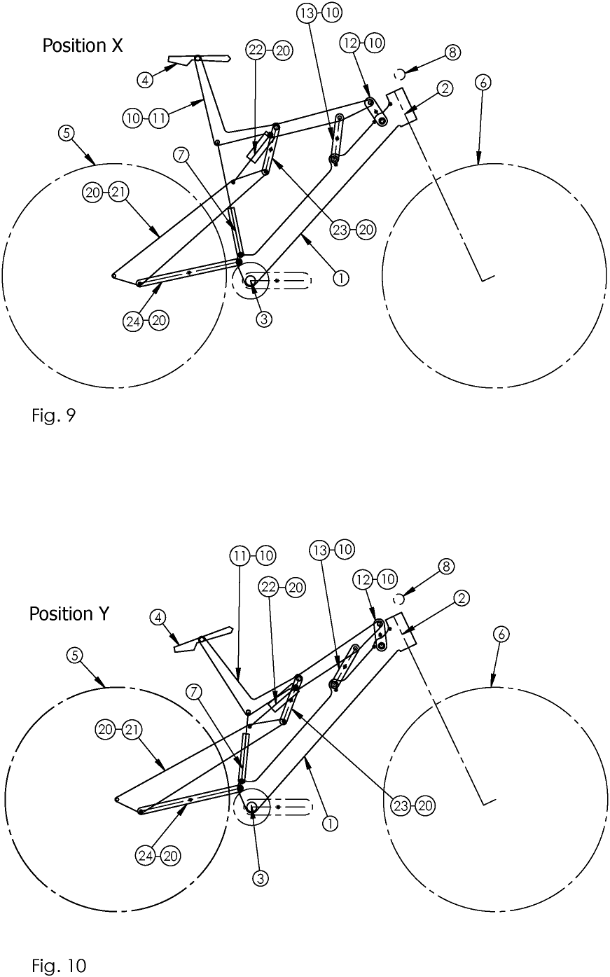

FIG. 8 - shows a side view of the frame parts shown in FIG. 7

FIG. 9 - shows the side view of the bicycle equipped with the frame described by claims 1, 3, 6, 11, 13 in X position

FIG. 10 - shows the side view of the bicycle equipped with the frame described by claims 1, 3, 6, 11, 13 in Y position

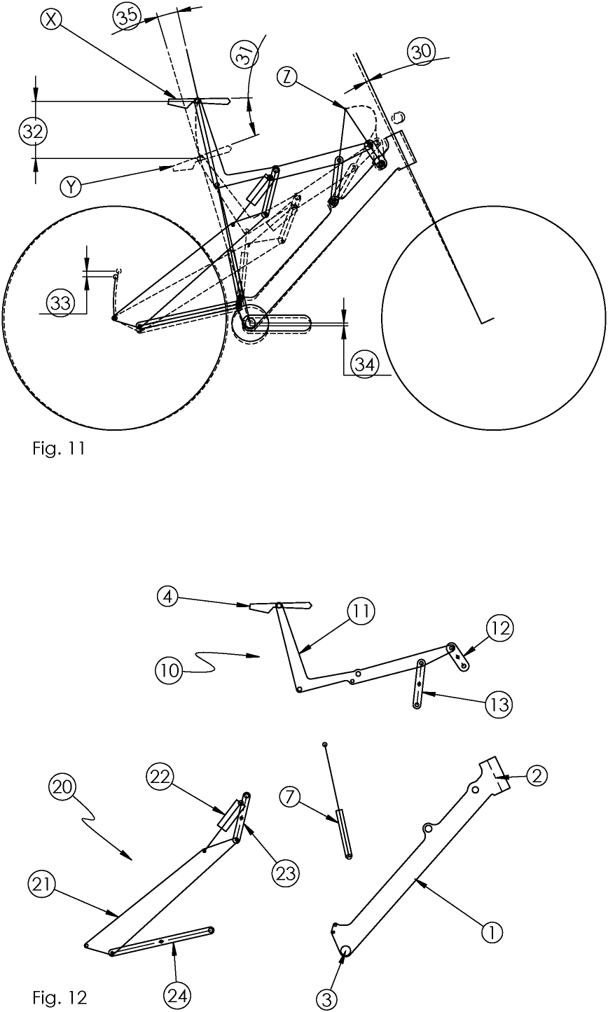

FIG. 11 - shows a schematic superimposition of the frame positions of FIG. 9 and FIG. 10

FIG. 12 - shows a side view of the frame parts shown in FIG. 11

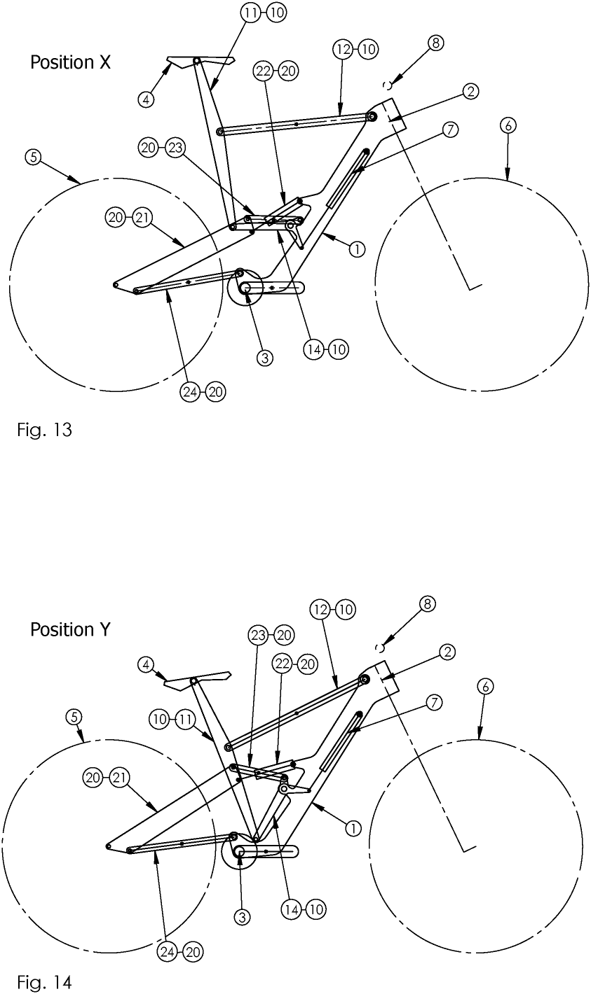

FIG. 13 - shows the side view of the bicycle equipped with the frame described by claims 1, 9, 10, 11, 13 in X position

FIG. 14 - shows the side view of the bicycle equipped with the frame described by claims 1, 9, 10, 11, 13 in Y position

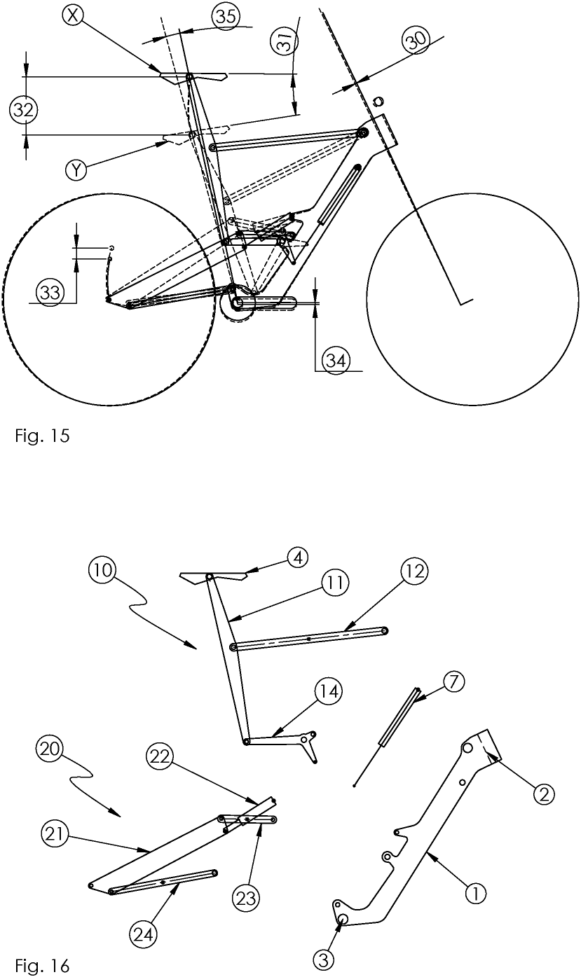

FIG. 15 - shows a schematic superimposition of the frame positions of FIG. 13 and FIG. 14

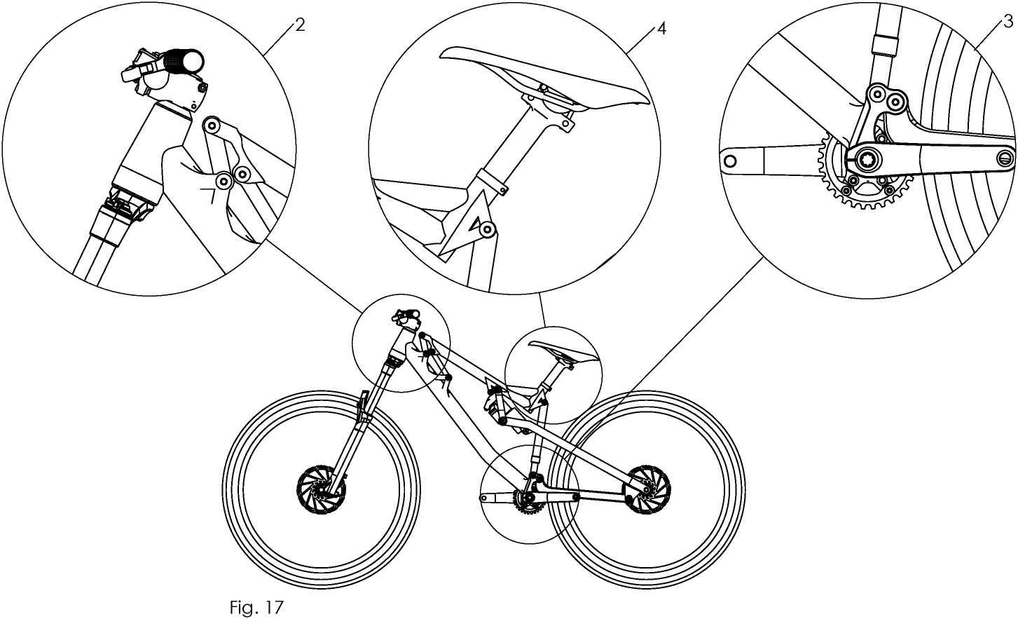

FIG. 16 - shows a side view of the frame parts shown in FIG. 15

As disclosed in FIG. 1, FIG. 2, FIG. 3 and FIG. 4, the bicycle frame consisting of the bearing element 1 comprises the front fork mount 2 and the crankset mount 3, the seat constructional part 10 comprises a saddle’s 4 clamp, the adjusting assembly 7, the rear wheel suspension set 20 comprises a swingarm 21 and a shock absorber 22. The bearing element 1 is connected by one articulated joint to the seat constructional part 10 and by one articulated joint to the rear wheel suspension set 20. The seat constructional part 10 is connected by one articulated joint to the rear wheel suspension set 20. The adjusting assembly 7 is movable within the range from the X position to Y position. The seat constructional part 10 extends from saddle’s 4 clamp downwards and then towards the front fork mount 2, where the seat constructional part 10 is articulated with the bearing element 1. The rear wheel suspension set 20 is connected by the swingarm 21 to the bearing element 1 in the area above the crankset mount 3. The swingarm 21 connects to the shock absorber 22 which connects to the seat constructional part 10, at a central portion thereof so that the shock absorber is directed toward the handlebars and operates at an angle of 30-40 degrees from horizontal. The adjusting assembly 7 is the fixed between the bearing element 1 and the seat constructional part 10, above the crankset mount 3, in the direction of the saddle’s 4 clamp in X position. It comprises a spring or a pneumatic or hydraulic cylinder operating within the range from the Y position to the X position, with a position lock. The frame joints are rotatable, movable in a plane perpendicular to the axis of the rear wheel 5.

This is the most elementary solution of the invention, which, with a lightweight and economical design, allows the parameters described in FIG. 3. to be adjusted over ranges approaching:
the head tube angle 30 – 1 degree,
the saddle angle 31 – 13 degrees,
the height of the saddle relative to the crankset mount 32 – 70 mm
the rear suspension set stroke 33 – 20 mm
the crankset mount height above the ground 34 – 12 mm
the seat tube effective angle 35 – 5 degrees,
where the above-mentioned parameters are estimated for frames of size L, i.e. dedicated to cyclists of height about 180 mm.

In the second example of implementation, illustrated in FIG. 5, FIG. 6, FIG. 7 and FIG. 8, the solution differs from the first example, described in FIG. 1, FIG. 2, FIG. 3 and FIG. 4 in that it uses a rear wheel suspension set 20 comprising the lower suspension link 24 extending from a connection with the bearing element 1 in the connecting area of the crankset mount 3 to a connection with a swingarm 21 in the area between the rear wheel 5 mount and the crankset mount 3. In addition, the swingarm 21 is connected to the shock absorber 22 and the upper suspension link 23, which, intersecting each other, connect to the seat constructional part 10, at a central part thereof. The four-bar-suspension system greatly improves the adjustment ranges of the parameters described in FIG. 7., making them more desirable
the head tube angle 30 – 0,5 degree
the saddle angle 31 – 16 degrees
the height of the saddle relative to the crankset mount 32 – 180 mm
the rear suspension set stroke 33 – 35 mm
the crankset mount height above the ground 34 – 7 mm
the seat tube effective angle 35 – 5 degrees,
where the above-mentioned parameters are estimated for frames of size L, i.e. dedicated to cyclists of height about 180 mm. In addition, anti-squat (the effect of drive on suspension shrinkage), adjusted at 25%, and anti-rise (the effect of braking on suspension shrinkage), adjusted at 30%, also change favorably.

Another solution shown in FIG. 9, FIG. 10, FIG. 11 and FIG. 12 disclose the use of a four-hinged arrangement of the constructional part, which is a distinction from the second example described in FIG. 5, FIG. 6, FIG. 7 and FIG. 8. The seat constructional part 10 comprises a saddle support 11 extending from the saddle’s 4 clamp downwards and then towards the front fork mount. The saddle support 11 is connected to the bearing element 1 via an upper constructional link 12 and via a lower constructional link 13, so that the upper constructional link 12 is closer to the front fork mount than the lower constructional link 13, and the axes of the links, formed by drawing lines through the link connection points, cross at a point Z located behind the handlebars set 8.

The four-hinged seat constructional part allows the designed advantageous lowering path of the saddle. significantly improves the adjustment ranges of the parameters described in FIG. 11., making them more desirable:
the head tube angle 30 – 1
the saddle angle 31 – 19 degrees
the height of the saddle relative to the crankset mount 32 – 180 mm
the rear suspension set stroke 33 – 20 mm
the crankset mount height above the ground 34 – 9 mm
the seat tube effective angle 35 – 4 degrees,
where the above-mentioned parameters are estimated for frames of size L, i.e. dedicated to cyclists of height about 180 mm In addition, anti-squat (the effect of drive on suspension shrinkage), adjusted at 25%, and anti-rise (the effect of braking on suspension shrinkage), adjusted at 30%, also change favorably.

FIGS. 13., 14., 15. and 16. show a further example of a design, the seat constructional part 10 of which includes a upper constructional link 12 articulated with the bearing element 1 in the front fork mount 2 area and articulated with the saddle support 11 in a central part. The saddle support 11 is vertically oriented, with its upper end connected to the saddle 4. The seat constructional part 10 also includes a triple-arm lever. This lever is pivotally connected to the bearing element 1, and with its arms pivotally connected to the lower end of the saddle support 11, the adjustment assembly 7 and the rear wheel suspension set 20. The rear wheel suspension set 20 in this embodiment includes a lower suspension link 24 connected to the bearing element 1 in the area of the crankset mount 3, and connected to a swingarm 21 in the area between the rear wheel 5 mount and the crankset mount 3. The swingarm 21 is connected to the upper suspension link 23 and a shock absorber 22. These intersecting links respectively connect the upper suspension link 23 to the triple-arm lever 14 and the shock absorber 22 to the bearing element 1 at a central portion thereof. The adjusting portion 7 is fixed between the bearing element 1 and the triple-arm lever 14, in such a way that one end is fixed near the front fork mount 2 and is directed along the bearing element 1. Its design and mode of operation is analogous to the other examples. The frame joints are rotatable, movable in a plane perpendicular to the axis of the rear wheel 5.

This is the most advantageous variant of the invention shown, which optimizes the regulatory range of the parameters, described in FIG. 15. in ranges close to:
the head tube angle 30 – 0,5 degree
the saddle angle 31 – 9 degrees
the height of the saddle relative to the crankset mount 32 – 185 mm
the rear suspension set stroke 33 – 20 mm
the crankset mount height above the ground 34 – 7 mm
the seat tube effective angle 35 – 3 degrees,
where the above-mentioned parameters are estimated for frames of size L, i.e. dedicated to cyclists of height about 180 mm. In addition, anti-squat (the effect of drive on suspension shrinkage), adjusted at 35%, and anti-rise (the effect of braking on suspension shrinkage), adjusted at 30%, also change favorably.

1. A bicycle frame consisting of a bearing element (1) comprises a front fork mount (2) and a crankset mount (3), a seat constructional part (10) comprises a saddle’s (4) clamp, an adjustment part (7), a rear wheel suspension set (20) comprises a swingarm (21) and a shock absorber (22)
characterized in that,
the bearing element (1) is connected by at least one articulated joint to the seat constructional part (10) and by at least one articulated joint to the rear wheel suspension set (20), and the seat constructional part (10) is connected by at least one articulated joint to the rear wheel suspension set (20) and the adjustment part (7) is movable within the range from X position to Y position.

2. The bicycle frame according to claim 1, wherein the seat constructional part (10) extends from the saddle’s (4) clamp downwards and then towards the front fork mount (2), where it is articulated with the bearing element (1), movably in a plane perpendicular to a rear wheel (5) axis, and the rear wheel suspension set (20) is connected by the swingarm (21) to the bearing element (1) in the area above the crankset mount (3); and the swingarm (21) connects to the shock absorber (22) which connects to the seat constructional part (10), where said connections are articulated joints movable in the plane perpendicular to the rear wheel (5) axis, and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

3. The bicycle frame according to claim 1, wherein the seat constructional part (10) comprises a saddle support (11) extending from the saddle’s (4) clamp downwards and then towards the front fork mount (2), where it is connected to the bearing element (1) via an upper constructional link (12) and via a lower constructional link (13), so that the upper constructional link (12) is closer to front fork mount than lower constructional link (13), and the axes of the links, formed by drawing lines through the link connection points, cross at a point Z near a handlebar (8) where said joints are movable in the planes perpendicular to an axis of a rear wheel (5), and the rear wheel suspension set (20) is connected by the swingarm (21) to the bearing element (1) in the area above the crankset mount (3); and the swingarm (21) connects to the shock absorber (22) which connects to the seat constructional part (10), where said connections are articulated joints movable in the plane perpendicular to the rear wheel (5) axis, and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

4. The bicycle frame according to claim 1, wherein the seat constructional part (10) comprises an upper constructional link (12) articulated with the bearing element (1) in the front fork mount (2) area and articulated with the saddle support (11) in central part; and the saddle support (11) is vertically oriented, with an upper end connected to the saddle (4) and with a lower end connected to a lower constructional link (13) which is connected to the bearing element (1) between the crankset mount (3) and the front fork mount (2), where all joints are movable in the plane perpendicular to the rear wheel (5) axis, and the rear wheel suspension set (20) is connected by the swingarm (21) to the bearing element (1) in the area above the crankset mount (3); and the swingarm (21) connects to the shock absorber (22) which connects to the seat constructional part (10), where said connections are articulated joints movable in the plane perpendicular to the rear wheel (5) axis, and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

5. (canceled)

6. (canceled)

7. (canceled)

8. (canceled)

9. The bicycle frame according to claim 1, wherein the seat constructional part (10) comprises an upper constructional link (12), articulated with the bearing element (1) in the front fork mount (2) mounting area and articulated with a saddle support (11) in central portion; and the saddle support (11) is vertically oriented with its upper end connected to the saddle (4), and a triple-arm lever (14) rotatably connected to the bearing element (1) and with its arms articulated to the lower end of the saddle support (11), the adjustment part (7) and rear wheel suspension set (20), where all connections are movable in the plane perpendicular to the rear wheel (5) axis, and the rear wheel suspension set (20) comprises a lower suspension link (24) connected to the bearing element (1) in the area of the crankset mount (2) and connected to the swingarm (21) in the area between the rear wheel (5) mounting and the crankset mount (3); and the swingarm (21) connected to the upper suspension link (23) and the shock absorber (22) which are respectively connected the suspension upper link (23) to the three-arm lever (14) and the shock absorbing member (22) to the support member (1), where the said connections are articulated joints movable in the plane perpendicular to the axis of the rear wheel (5), and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

10. (canceled)

11. (canceled)

12. (canceled)

13. (canceled)

14. (canceled)

15. Method for dynamic changes to the geometry of a bicycle frame in the parameters of a saddle angle (31), a saddle height relative to crankset bracket (32), a rear suspension stroke (33), utilizing an adjustment part (7) for variable length
characterized in that
the bicycle frame is a shock absorbing lever mechanism, which is raised towards the X position by releasing a lock of the adjustment part (7) and fixed in a position between the X and the Y of the saddle (4) by pressing on the saddle (4) and locking the adjustment part (7) again.

16. The bicycle frame according to claim 1, wherein the seat constructional part (10) extends from the saddle’s (4) clamp downwards and then towards the front fork mount (2), where it is articulated with the bearing element (1), movably in a plane perpendicular to a rear wheel (5) axis, and he rear wheel suspension set (20) comprises a lower suspension link (24) extending from the connection with the bearing element (1) in the crankset mount (3) area to a connection to the swingarm (21) in the area between the rear wheel (5) mount and the crankset mount (3); and the swingarm (21) is connected to the shock absorber (22) and a upper suspension link (23) which are connected to the seat constructional part (10) where said connections are articulated movable in the plane perpendicular to the rear wheel (5) axis, and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

17. The bicycle frame according to claim 1, wherein the seat constructional part (10) extends from the saddle’s (4) clamp downwards and then towards the front fork mount (2), where it is articulated with the bearing element (1), movably in a plane perpendicular to a rear wheel (5) axis, and the rear wheel suspension set (20) comprises a lower suspension link (24) extending from the connection with the bearing element (1) in the connecting area of the crankset mount (3) to a connection to the swingarm (21) in the area between the rear wheel (5) mount and the crankset mount (3); and the swingarm (21) is connected to an upper suspension link (23), which is connected by its opposite end to the seat constructional part (10) or the bearing element (1), and the shock absorber (22), is connected to the upper suspension link (23) and the seat constructional part (10), where said connections are articulated connections movable in a plane perpendicular to the axis of the rear wheel (5), and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

18. The bicycle frame according to claim 1, wherein the seat constructional part (10) extends from the saddle’s (4) clamp downwards and then towards the front fork mount (2), where it is articulated with the bearing element (1), movably in a plane perpendicular to a rear wheel (5) axis, and the rear wheel suspension set (20) comprises the swingarm (21) connected to the bearing element (1) in the connecting area of the crankset mount (3) and a lower suspension link (24) connected to the swingarm (21); and an upper suspension link (23) connected to the lower suspension link (24) and the seat constructional part (10) or the bearing element (1) to which the shock absorber (22) is connected, which connects to the seat constructional part (10), where the said connections are articulated joints in the plane perpendicular to the axis of the rear wheel (5), and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

19. The bicycle frame according to claim 1, wherein the seat constructional part (10) comprises a saddle support (11) extending from the saddle’s (4) clamp downwards and then towards the front fork mount (2), where it is connected to the bearing element (1) via an upper constructional link (12) and via a lower constructional link (13), so that the upper constructional link (12) is closer to front fork mount than lower constructional link (13), and the axes of the links, formed by drawing lines through the link connection points, cross at a point Z near a handlebar (8) where said joints are movable in the planes perpendicular to the axis of a rear wheel (5), and the rear wheel suspension set (20) comprises a lower suspension link (24) extending from the connection with the bearing element (1) in the crankset mount (3) area to a connection to the swingarm (21) in the area between the rear wheel (5) mount and the crankset mount (3); and the swingarm (21) is connected to the shock absorber (22) and a upper suspension link (23) which are connected to the seat constructional part (10) where said connections are articulated movable in the plane perpendicular to the rear wheel (5) axis, and the adjustment part (7) is the fixed between the bearing element (1) and the seat constructional part (10) by articulated joints movable in a plane perpendicular to the rear wheel (5) axis, 13 and the adjustment part (7) comprises a spring or a pneumatic or hydraulic cylinder operating within the range from the Y position to the X position, with a position lock, and the position lock of the adjustment part (7) is released by means of a handlebar shifter.

20. The bicycle frame according to claim 1, wherein the seat constructional part (10) comprises a saddle support (11) extending from the saddle’s (4) clamp downwards and then towards the front fork mount (2), where it is connected to the bearing element (1) via an upper constructional link (12) and via a lower constructional link (13), so that the upper constructional link (12) is closer to front fork mount than lower constructional link (13), and the axes of the links, formed by drawing lines through the link connection points, cross at a point Z near a handlebar (8) where said joints are movable in the planes perpendicular to the axis of a rear wheel (5), and the rear wheel suspension set (20) comprises a lower suspension link (24) extending from the connection with the bearing element (1) in the connecting area of the crankset mount (3) to a connection to the swingarm (21) in the area between the rear wheel (5) mount and the crankset mount (3); and the swingarm (21) is connected to an upper suspension link (23), which is connected by its opposite end to the seat constructional part (10) or the bearing element (1), and the shock absorber (22), is connected to the upper suspension link (23) and the seat constructional part (10), where said connections are articulated connections movable in a plane perpendicular to the axis of the rear wheel (5), and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

21. The bicycle frame according to claim 1, wherein the seat constructional part (10) comprises a saddle support (11) extending from the saddle’s (4) clamp downwards and then towards the front fork mount (2), where it is connected to the bearing element (1) via an upper constructional link (12) and via a lower constructional link (13), so that the upper constructional link (12) is closer to front fork mount than lower constructional link (13), and the axes of the links, formed by drawing lines through the link connection points, cross at a point Z near a handlebar (8) where said joints are movable in the planes perpendicular to the axis of a rear wheel (5), and the rear wheel suspension set (20) comprises the swingarm (21) connected to the bearing element (1) in the connecting area of the crankset mount (3) and a lower suspension link (24) connected to the swingarm (21); and an upper suspension link (23) connected to the lower suspension link (24) and the seat constructional part (10) or the bearing element (1) to which the shock absorber (22) is connected, which connects to the seat constructional part (10), where the said connections are articulated joints in the plane perpendicular to the axis of the rear wheel (5), and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

22. The bicycle frame according to claim 1, wherein the seat constructional part (10) comprises a saddle support (11) extending from the saddle’s (4) clamp downwards and then towards the front fork mount (2), where it is connected to the bearing element (1) via an upper constructional link (12) and via a lower constructional link (13), so that the upper constructional link (12) is closer to front fork mount than lower constructional link (13), and the axes of the links, formed by drawing lines through the link connection points, cross at a point Z near a handlebar (8) where said joints are movable in the planes perpendicular to the axis of a rear wheel (5), and the rear wheel suspension set (20) comprises a lower suspension link (24) extending from the connection with the bearing element (1) in the crankset mount (3) area to a connection to the swingarm (21) in the area between the rear wheel (5) mount and the crankset mount (3); and the swingarm (21) is connected to the shock absorber (22) and a upper suspension link (23) which are connected to the seat constructional part (10) where said connections are articulated movable in the plane perpendicular to the rear wheel (5) axis, the adjustment part (7) is connected to an element of the seat constructional parts (10), next to the connection of the seat constructional part (10) and the bearing element (1), in the area of the front fork mount (2), and the opposite end being connected to another element of the seat adjustment parts (10), where the said articulated joints are moveable in the plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

23. The bicycle frame according to claim 1, wherein the seat constructional part (10) comprises a saddle support (11) extending from the saddle’s (4) clamp downwards and then towards the front fork mount (2), where it is connected to the bearing element (1) via an upper constructional link (12) and via a lower constructional link (13), so that the upper constructional link (12) is closer to front fork mount than lower constructional link (13), and the axes of the links, formed by drawing lines through the link connection points, cross at a point Z near a handlebar (8) where said joints are movable in the planes perpendicular to the axis of a rear wheel (5), and the rear wheel suspension set (20) comprises a lower suspension link (24) extending from the connection with the bearing element (1) in the connecting area of the crankset mount (3) to a connection to the swingarm (21) in the area between the rear wheel (5) mount and the crankset mount (3); and the swingarm (21) is connected to an upper suspension link (23), which is connected by its opposite end to the seat constructional part (10) or the bearing element (1), and the shock absorber (22), is connected to the upper suspension link (23) and the seat constructional part (10), where said connections are articulated connections movable in a plane perpendicular to the axis of the rear wheel (5), and the adjustment part (7) is connected to an element of the seat constructional parts (10), next to the connection of the seat constructional part (10) and the bearing element (1), in the area of the front fork mount (2), and the opposite end being connected to another element of the seat adjustment parts (10), where the said articulated joints are moveable in the plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

24. The bicycle frame according to claim 1, wherein the seat constructional part (10) comprises a saddle support (11) extending from the saddle’s (4) clamp downwards and then towards the front fork mount (2), where it is connected to the bearing element (1) via an upper constructional link (12) and via a lower constructional link (13), so that the upper constructional link (12) is closer to front fork mount than lower constructional link (13), and the axes of the links, formed by drawing lines through the link connection points, cross at a point Z near a handlebar (8) where said joints are movable in the planes perpendicular to the axis of a rear wheel (5), and the rear wheel suspension set (20) comprises the swingarm (21) connected to the bearing element (1) in the connecting area of the crankset mount (3) and a lower suspension link (24) connected to the swingarm (21); and an upper suspension link (23) connected to the lower suspension link (24) and the seat constructional part (10) or the bearing element (1) to which the shock absorber (22) is connected, which connects to the seat constructional part (10), where the said connections are articulated joints in the plane perpendicular to the axis of the rear wheel (5), and the adjustment part (7) is connected to an element of the seat constructional parts (10), next to the connection of the seat constructional part (10) and the bearing element (1), in the area of the front fork mount (2), and the opposite end being connected to another element of the seat adjustment parts (10), where the said articulated joints are moveable in the plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

25. The bicycle frame according to claim 1, wherein the seat constructional part (10) comprises an upper constructional link (12) articulated with the bearing element (1) in the front fork mount (2) area and articulated with the saddle support (11) in central part; and the saddle support (11) is vertically oriented, with an upper end connected to the saddle (4) and with a lower end connected to a lower constructional link (13) which is connected to the bearing element (1) between the crankset mount (3) and the front fork mount (2), where all joints are movable in the plane perpendicular to the rear wheel (5) axis, and the rear wheel suspension set (20) comprises a lower suspension link (24) extending from the connection with the bearing element (1) in the crankset mount (3) area to a connection to the swingarm (21) in the area between the rear wheel (5) mount and the crankset mount (3); and the swingarm (21) is connected to the shock absorber (22) and a upper suspension link (23) which are connected to the seat constructional part (10) where said connections are articulated movable in the plane perpendicular to the rear wheel (5) axis, and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

26. The bicycle frame according to claim 1, wherein the seat constructional part (10) comprises an upper constructional link (12) articulated with the bearing element (1) in the front fork mount (2) area and articulated with the saddle support (11) in central part; and the saddle support (11) is vertically oriented, with an upper end connected to the saddle (4) and with a lower end connected to a lower constructional link (13) which is connected to the bearing element (1) between the crankset mount (3) and the front fork mount (2), where all joints are movable in the plane perpendicular to the rear wheel (5) axis, and the rear wheel suspension set (20) comprises a lower suspension link (24) extending from the connection with the bearing element (1) in the connecting area of the crankset mount (3) to a connection to the swingarm (21) in the area between the rear wheel (5) mount and the crankset mount (3); and the swingarm (21) is connected to an upper suspension link (23), which is connected by its opposite end to the seat constructional part (10) or the bearing element (1), and the shock absorber (22), is connected to the upper suspension link (23) and the seat constructional part (10), where said connections are articulated connections movable in a plane perpendicular to the axis of the rear wheel (5), and the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

27. The bicycle frame according to claim 1, wherein the seat constructional part (10) comprises an upper constructional link (12) articulated with the bearing element (1) in the front fork mount (2) area and articulated with the saddle support (11) in central part; and the saddle support (11) is vertically oriented, with an upper end connected to the saddle (4) and with a lower end connected to a lower constructional link (13) which is connected to the bearing element (1) between the crankset mount (3) and the front fork mount (2), where all joints are movable in the plane perpendicular to the rear wheel (5) axis, and the rear wheel suspension set (20) comprises the swingarm (21) connected to the bearing element (1) in the connecting area of the crankset mount (3) and a lower suspension link (24) connected to the swingarm (21); and an upper suspension link (23) connected to the lower suspension link (24) and the seat constructional part (10) or the bearing element (1) to which the shock absorber (22) is connected, which connects to the seat constructional part (10), where the said connections are articulated joints in the plane perpendicular to the axis of the rear wheel (5), the adjustment part (7) is the fixed between the bearing element (1) and the seat constructional part (10) by articulated joints movable in a plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

28. The bicycle frame according to claim 1, wherein the seat constructional part (10) comprises an upper constructional link (12) articulated with the bearing element (1) in the front fork mount (2) area and articulated with the saddle support (11) in central part; and the saddle support (11) is vertically oriented, with an upper end connected to the saddle (4) and with a lower end connected to a lower constructional link (13) which is connected to the bearing element (1) between the crankset mount (3) and the front fork mount (2), where all joints are movable in the plane perpendicular to the rear wheel (5) axis, and the rear wheel suspension set (20) comprises a lower suspension link (24) extending from the connection with the bearing element (1) in the crankset mount (3) area to a connection to the swingarm (21) in the area between the rear wheel (5) mount and the crankset mount (3); and the swingarm (21) is connected to the shock absorber (22) and a upper suspension link (23) which are connected to the seat constructional part (10) where said connections are articulated movable in the plane perpendicular to the rear wheel (5) axis, and the adjustment part (7) is connected to an element of the seat constructional parts (10), next to the connection of the seat constructional part (10) and the bearing element (1), in the area of the front fork mount (2), and the opposite end being connected to another element of the seat adjustment parts (10), where the said articulated joints are moveable in the plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.

29. The bicycle frame according to claim 1, wherein the seat constructional part (10) comprises an upper constructional link (12), articulated with the bearing element (1) in the front fork mount (2) mounting area and articulated with a saddle support (11) in central portion; and the saddle support (11) is vertically oriented with its upper end connected to the saddle (4), and a triple-arm lever (14) rotatably connected to the bearing element (1) and with its arms articulated to the lower end of the saddle support (11), the adjustment part (7) and rear wheel suspension set (20), where all connections are movable in the plane perpendicular to the rear wheel (5) axis, and the rear wheel suspension set (20) comprises a lower suspension link (24) connected to the bearing element (1) in the area of the crankset mount (2) and connected to the swingarm (21) in the area between the rear wheel (5) mounting and the crankset mount (3); and the swingarm (21) connected to the upper suspension link (23) and the shock absorber (22) which are respectively connected the suspension upper link (23) to the three-arm lever (14) and the shock absorbing member (22) to the support member (1), where the said connections are articulated joints movable in the plane perpendicular to the axis of the rear wheel (5), and the adjustment part (7) is connected to an element of the seat constructional parts (10), next to the connection of the seat constructional part (10) and the bearing element (1), in the area of the front fork mount (2), and the opposite end being connected to another element of the seat adjustment parts (10), where the said articulated joints are moveable in the plane perpendicular to the rear wheel (5) axis, and the adjustment part (7) comprises a spring or a pneumatic or hydraulic cylinder operating within the range from the Y position to the X position, with a position lock, and the position lock of the adjustment part (7) is released by means of a handlebar shifter.
